(19) United States
(12) Patent Application Publication
(10) Pub. No.: US 2005/0229752 A1
(43) Pub. Date: Oct. 20, 2005

(54) Low profile locking socket wrench universal joint

(76) Inventor: Michael F. Nickipuck, Homer Glen, IL (US)

Correspondence Address: BARNES & THORNBURG, P.O. BOX 2786, CHICAGO, IL, 60690-2786, US

(21) Appl. No.: 11/110,013

(22) Filed: Apr. 20, 2005

Related U.S. Application Data
(60) Provisional application No. 60/563,729, filed on Apr. 20, 2004.

(51) Int. Cl. B25B 23/16; B25G 1/00

(52) U.S. Cl. 81/177.75

(57) ABSTRACT

A low profile locking socket drive universal joint uses a compact locking mechanism with a control bar and a transverse actuator assembly connected to a sleeve to lock a socket to a drive stud with dual function tensioning springs, flexing clevis arms, movable spring seat and closely spaced universal coupler axes all contributing to a short, fatigue resistant universal joint that additionally supports sockets close the drive axis at rest to operator advantage and limits movement skewed to the drive axis to substantially 45°.

### CLAIM OF PRIORTY

This application claims priority based on Provisional Application Ser. No. 60/563,729 filed Apr. 20, 2004, and having the same title and inventor.

### BACKGROUND OF THE INVENTION

1. Field of the Invention

A low profile universal joint is used in connection with socket wrench sets that enables application of force to a fastener at an angle off the axis of rotation of the fastener by turning a wrench handle such as ratchet or breaker bar. The low profile universal joint enables the locking of a socket to the universal joint and the release of the socket by selectively retracting the circumferential sleeve, accomplished in a length equivalent to the length of a non-locking universal joint.

2. Description of Related Art

Releasing ratchet handles, locking socket wrench extensions and a few locking universal joints are known. The ends for locking extensions have been adapted to universal joints having a length significantly greater than standard universal joints, such as shown in FIG. 4. This prior art feature provides a disadvantage in compactness.

Locking solutions have generally included three locking pins which must be depressed with a probe, hand-held pin or other device as used for many years in impact tools, central axis tapered pins and surface channel control bars.

The typical control bar solutions on extensions, including short bodies pinned to longer extensions include the Nickipuck family of patents, U.S. Pat. Nos. 4,480,511, 4,768,405, 4,805,549, 4,938,107 and 5,042,332.

These patents are incorporated by reference as if fully set forth herein.

The prior art non-locking universal joint shown in the drawings is typical of a high quality socket drive tool, and for a ⅜″ drive socket set has a length “Lpa” of about 1⅝″ and a width “Wpa” of about 11/16″, or a ratio of about 2.4. Other prior art non-locking socket drive tools have L/W ratios of up to about 3.

Other prior art includes alternatives showing locking universal joints, but all these appear to have central pins and are believed to be neither as compact as, nor as functional in locking and retaining sockets as the present disclosure.

### SUMMARY OF INVENTION

A socket driving universal joint combines a number of features.

The universal joint has semi-automatic locking. A locking sleeve and mechanism permits selective releasing of a fastener driving member such as a socket. In addition to locking and releasing, the universal joint limits the angle of skew of the driving, male end from the axis of the driven, female end. Nevertheless the universal joint has adequate flexibility to impart driving torque under load with resistance to flexibility to avoid loss of directional control while attaching and detaching a socket to a fastener. The tension spring and stressed clevis arm arrangement provides improved performance in fatigue resistance. This is accomplished in a compact length through the use of a universal coupling member with overlapping pin screw holes.

### BRIEF DESCRIPTION OF THE DRAWINGS

FIG. 1 is an elevational view of a universal joint.

FIG. 2 is an exploded perspective view of the universal joint.

FIG. 3 is an exploded elevational view of the universal joint.

FIG. 4 is a perspective view of a standard, non-locking Universal joint.

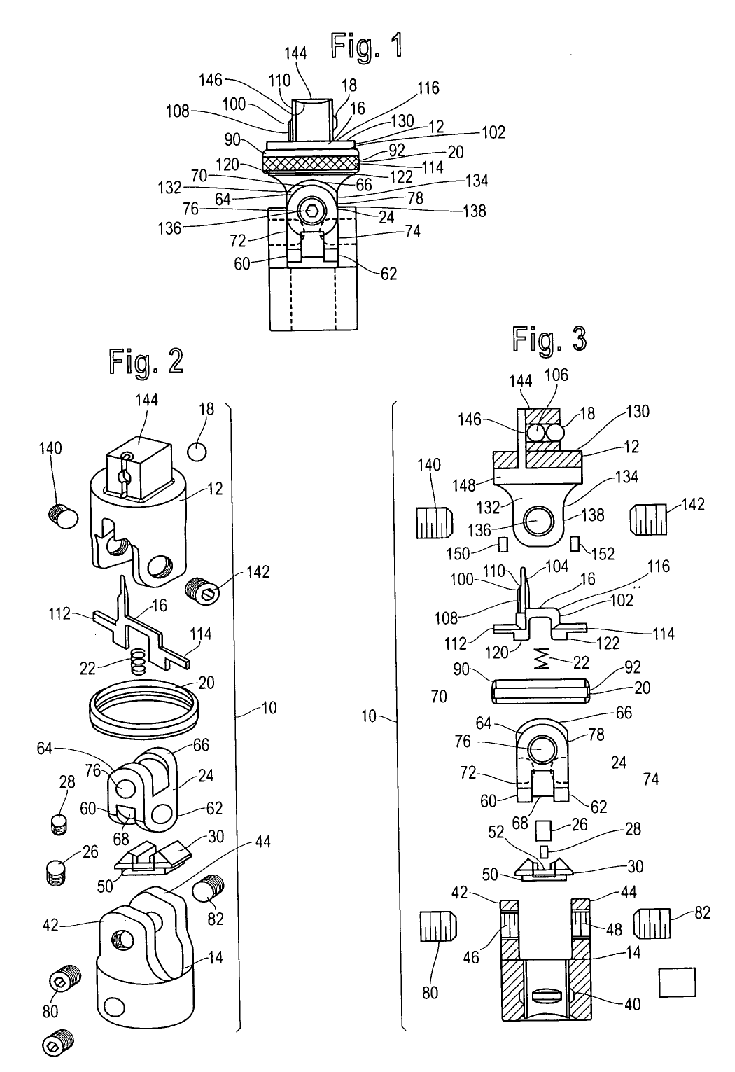

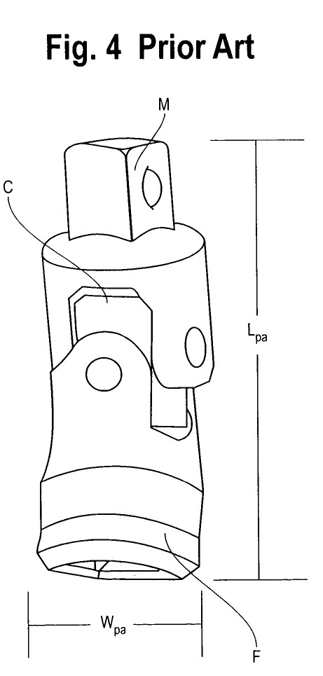

### DESCRIPTION OF PREFERRED EMBODIMENTS

A locking universal joint 10 receives rotative force from a ratchet handle (not shown) applied to a female driven end 11, the torque being transmitted through the universal joint 10 to a driving male end 14. In end 14, slide key 16 positively locks the socket S in place by displacing lock ball 18 transversely. Manually actuated release sleeve 20 moves the slide key 16 against a lock spring 22 urges the slide key 16 upward, against intermediate ball 24 in turn applying load on lock ball 18.

Coupling member 26 is tensioned by large tension spring 28 and small tension spring 30 against a floating saddle and spring stop 32 which seats on driven end 11.

Driving member or male end 14 has a body 40 with left and right clevis arms 42, 44 defining a coupler receiving area between them. A ratchet receiving receptacle 45 will receive the common square drive or alternative drives such as hex or spline, star, Torx or other similar configurations. While direct receipt of a drive handle is contemplated, one of ordinary skill will understand that various combinations of socket drive tools can be used at various stages—thus the Universal joint could be between two extensions, between a drive handle and an extension, between an extension and a socket, as well as the simple drive handle—Universal joint—socket arrangement. Each arm 42, 44 has a threaded pin aperture 46, 48. Saddle 30 will actually be rotated from the view shown for clarity in FIG. 3 so that projection 50 fits in and spans receptacle 45.

Spring seat 52 receives springs 26, 28. Springs 26 and 28 are coil springs that fit within one another in a telescoping fashion to use the fatigue resistance of coil springs in a compact arrangement. Prior art typically applies tension in universal joints with fatigue prone lock washer style springs.

Universal coupling member 24 has left and right bosses 60, 62 and front and rear bosses 64, 66, defining lands 68, 70 between them. The terminology with respect to these members, left, right, front and rear is used with reference to the drawings, it being understood the member rotates in use and the orientation changes. Thus, the terminology is only used with reference to the drawings and is not intended to limit the invention. Springs 26, 28 bear on land 68. Within bosses 60, 62 are pin receiving apertures 72, 74. Within bosses 64, 66 are apertures 76, 78. Set screws 80, 82 are received in threaded apertures 46, 48 and continue projecting inwardly threadily connecting apertures 72, 74. The threads cut in the respective apertures 46, 72 and 48, 74 are synchronized when cut to provide a continuous spiral path taking into account intolerances between the respective members. Additionally, rotation of the universal joint 10 about the axis of the screws and apertures will actually tighten the threaded assembly flexing arms 42, 44 slightly. The floating nature of saddle 30 thereby provides a fatigue resistant structure. The flexing of arms 42, 44 thus provides an additional resistance to the universal joint falling off the central axis, thus easing operation such as when a mechanic attempts to attach a drive socket in a remote area.

Sleeve 20 has an interior wall 90 relieved to provide a groove 92. Wall 90 closely conforms to the surface of driving member male end 12. Slide key 16 is formed substantially in an inverted “T” shape.

Slide key 16 has a vertical control bar structure 100 and a transverse actuator structure 102. Control bar structure 100 has a ramp 104 that directly contacts intermediate ball 106. Ball 106 transmits force between retainer ball 18 and control bar structure 100. Outer wall 108 will, when the device is in a locked position bear on an interior wall of a socket. Notch 110 will engage the edge of a socket to permit pushing the socket on the device to retract the locking mechanism. Thus, the socket can be placed on the device without retracting the sleeve 20. This operation is described in greater detail in the Nickipuck patents cited above and incorporated by reference herein in their entirety.

Actuator 102 has two opposed arms 112, 114 connected by a transverse cross piece 116 defining thereunder a spring ram 118 that receives spring 22. Stops 120, 122 provide limitation of motion when in the assembled condition and the locked condition by providing surfaces upon which arms 42, 44 abut when the universal joint is deflected to a maximum of 45°. As force transmission through the universal joint is generally ineffective past about 45°, it is a typical design flaw in standard universal joints that the universal joint can bend to an extreme angle whereby it is neither easy for an operator to align sockets nor is it feasible for the operator to transmit torque. All surfaces and arms are formed and arranged with this limitation in mind.

Driving member or male end 12 has a body 130 and clevis arms 132, 134. Arms 132, 134 have threaded apertures 136, 138 that receive set screws 140, 142 in the same manner at arms and apertures 42, 44, 46, 48 and the connection to threaded aperture 76, 78 and flexing of arms 132, 134 is affected in the same manner.

At the end of body 130 is a projecting drive member 144. Drive member 144 and body 130 are formed with channel 146 in which control bar portion 100 moves and is guided in channel 146 to engage and disengage ball 18 through ball 106. Channel 146 intersects transverse actuator channel 148 so that arms 112, 114 being engaged in slot 92 to permit the longitudinal movement of control bar portion 100.

Sleeve 20 being circular and corresponding closely to the diameter of body 130 must actually be distorted out of round to receive arms 112, 114. The elastic properties of the material then permit sleeve 130 to return to the circular configuration for assembly. As the aforementioned components are assembled, tension springs 150, 152 are received in apertures 153 located just inside arms 132, 134. Springs 150, 152 bear directly on bosses 64, 78 to provide additional tension tending to urge the axes of members 12, 24 and 14 into a straight alignment. As discussed above, this provides assistance to the operator in permitting better control and “aiming” of a drive socket to the line with the fastener in a difficult to reach location.

Universal coupling member 24 is formed with the axes of apertures 72, 74 and 76, 78 perpendicular. The spacing of the axes is such that at the diameter of the apertures and set screws, there would be an overlap of the respective cylinders defined by the extended diameters. Thus, by comparison to prior art universal joints using pins, a much closer spacing of the axes 72, 74 and 76, 78 can be accomplished. Should pins have been used, the pins would interfere with one another because their outer surfaces would overlap. The use of set screws, therefore, enables a much closer spacing. p Thus, the length L of the low profile locking universal joint relative to width W can be a ratio of less than three, optimally about 2.66 or less. Compared to prior art which considers a ratio of 5 to be advantageous, the instant invention is far superior.

While the present invention has been disclosed and described with reference to a single embodiment thereof, it will be apparent, as noted above that variations and modifications may be made therein. It is also noted that the present invention is independent of the particular tools used to impart rotational force and the particular tools driven, being not limited to those tools. It is, thus, intended in the following claims to cover each variation and modification that falls within the true spirit and scope of the present invention.

1. A low profile locking socket drive universal joint comprising:
driving and driven members pivotally interconnected with a coupler having perpendicular axes;
a locking mechanism adapted to selectively lock and unlock a mating tool;
tensioning springs, clevis arms, movable spring seat;
said members being formed and said coupler axes being spaced such that the ratio of total length to total width is less than 3;
said driving and driven members comprising respectively a first clevis member and a second clevis member pivotally coupled to one another having a longitudinally aligned central drive axis and first and second coupler axes perpendicular to the drive axis and to one another;
said locking mechanism being formed on the first clevis member and having a control bar and a transverse actuator assembly bearing on a socket tool lock;
said locking mechanism is operatively connected to a slidable sleeve to lock the socket tool to a drive stud;
a coupling member adapted to receive threaded pivot pins disposed in said first and second coupler axes, to enable rotary motion in the first clevis to be transmitted to rotary motion in the second clevis;
said first and second devises having pivot pins disposed at said first and second coupler axes, to enable pivoting relative to said first clevis, second clevis and coupling member;
dual function tensioning springs, seated on a movable spring seat and in association with the first and second devises to urge the locking mechanism into a locked position and to urge the universal joint into a centered position coaxial with the drive axis;
said first and second devises each having flexing clevis arms, tending to urge the universal joint into a centered position coaxial with the drive axis; said first and second coupler axes are spaced from one another a distance less than the diameters of said pivot pins;
said universal joint supports sockets close the drive axis at rest and limits movement skewed to the drive axis to substantially 45°;
said second clevis member has an exterior channel machined in a drive stub and an intersecting transverse slot for slidably receiving a substantially “T” shaped slide key;
said slide key “T” is formed of a vertical control bar and a transverse actuator;
said vertical control bar structure selectably bears on a locking ball arrangement for locking a tool to the drive stub;
actuator has two opposed arms which project transversely outwardly of said slot and having ends are receivable in a sleeve;
said sleeve capturing said ends;
first and second opposed pairs of pin receiving apertures being defined by first and second cylindrical walls and having first and second pin axes respectively being said axes are formed in said coupling member so said axes are perpendicular but longitudinally spaced from one another;
said walls being formed and arranged spacially so that if projected to extend through said member, said projected walls would intersect.
said first and second clevis members each having projecting clevis arms on opposite sides from one another;
said arms having cylindrical walls formed and positioned so that they are coaxial with said coupling member cylindrical walls when said universal joint is assembled;
said arm cylindrical walls and coupling member cylindrical walls are threaded so that the threads are synchronized;
said threaded cylindrical walls receiving correspondingly threaded pins;
said threaded pins, coupling member and arms coacting so that rotation of the universal joint and concomitant divergence from the longitudinal axis will tend to flex said arms;
a primary tensioning member fitted to urge said universal joint toward alignment along said drive axis;
a floating saddle fitted between the arms of said first clevis member; said coupling member has tension member receiving lands formed therein;
said tension member being received by said saddle and being interposed between said saddle and said coupling member.

2. A low profile locking socket drive universal joint for rotationally driving a socket tool, comprising:
a first clevis member and a second clevis member pivotally coupled to one another having a longitudinally aligned central drive axis and first and second coupler axes perpendicular to the drive axis and to one another;
a compact locking mechanism on the first clevis member with a control bar and a transverse actuator assembly bearing on a socket tool lock;
said locking mechanism is operatively connected to a slidable sleeve to lock the socket tool to a drive stud;
a coupling member adapted to receive threaded pivot pins disposed in said first and second coupler axes, to enable rotary motion in the first clevis to be transmitted to rotary motion in the second clevis;
said first and second devises having pivot pins disposed at said first and second coupler axes, to enable pivoting relative to said first clevis, second clevis and coupling member;
dual function tensioning springs, seated on a movable spring seat and in association with the first and second devises to urge the locking mechanism into a locked position and to urge the universal joint into a centered position coaxial with the drive axis;
said first and second devises each having flexing clevis arms, tending to urge the universal joint into a centered position coaxial with the drive axis;
said first and second coupler axes are spaced from one another a distance less than the diameters of said pivot pins;
said universal joint supports sockets close the drive axis at rest and limits movement skewed to the drive axis to substantially 45°.

3. The locking universal joint of claim 2 further comprising:
said second clevis member has an exterior channel machined in a drive stub and an intersecting transverse slot for slidably receiving a substantially “T” shaped slide key;
said slide key “T” is formed of a vertical control bar and a transverse actuator;
said vertical control bar structure selectably bears on a locking ball arrangement for locking a tool to the drive stub;
actuator has two opposed arms which project transversely outwardly of said slot and having ends are receivable in a sleeve;
said sleeve capturing said ends.

4. The locking universal joint of claim 3 further comprising:
said arms are interconnected by a transverse cross piece defining thereunder a spring ram;
said cross piece having projecting stops to provide limitation of motion when the universal joint is in the assembled condition and the locked condition by providing bearing surfaces when the universal joint is deflected to a maximum of 45°.

5. The locking universal joint of claim 3 further comprising:
said sleeve has an interior wall relieved to provide a groove;
said interior Wall closely conforms to the exterior surface of said second clevis member.

6. The locking universal joint of claim 2 said coupling member further comprising:
first and second opposed pairs of pin receiving apertures being defined by first and second cylindrical walls and having first and second pin axes respectively being said axes are formed in said coupling member so said axes are perpendicular but longitudinally spaced from one another;
said walls being formed and arranged spacially so that if projected to extend through said member, said projected walls would intersect.

7. The locking universal joint of claim 6 said further comprising:
said first and second clevis members each having projecting clevis arms on opposite sides from one another;
said arms having cylindrical walls formed and positioned so that they are coaxial with said coupling member cylindrical walls when said universal joint is assembled;
said arm cylindrical walls and coupling member cylindrical walls are threaded so that the threads are synchronized;
said threaded cylindrical walls receiving correspondingly threaded pins;
said threaded pins, coupling member and arms coacting so that rotation of the universal joint and concomitant divergence from the longitudinal axis will tend to flex said arms.

8. The locking universal joint of claim 7 said further comprising:
a primary tensioning member fitted to urge said universal joint toward alignment along said drive axis;
a floating saddle fitted between the arms of said first clevis member;
said coupling member has tension member receiving lands formed therein;
said tension member being received by said saddle and being interposed between said saddle and said coupling member.

9. A low profile locking socket drive universal joint comprising:
driving and driven members pivotally interconnected with a coupler having perpendicular axes;
a locking mechanism adapted to selectively lock and unlock a mating tool;
tensioning springs, clevis arms, movable spring seat;
said members being formed and said coupler axes being spaced such that the ratio of total length to total width is less than 3.

10. The locking universal joint of claim 9 further comprising:
said driving and driven members comprising respectively a first clevis member and a second clevis member pivotally coupled to one another having a longitudinally aligned central drive axis and first and second coupler axes perpendicular to the drive axis and to one another;
said locking mechanism being formed on the first clevis member and having a control bar and a transverse actuator assembly bearing on a socket tool lock;
said locking mechanism is operatively connected to a slidable sleeve to lock the socket tool to a drive stud;
a coupling member adapted to receive threaded pivot pins disposed in said first and second coupler axes, to enable rotary motion in the first clevis to be transmitted to rotary motion in the second clevis;
said first and second devises having pivot pins disposed at said first and second coupler axes, to enable pivoting relative to said first clevis, second clevis and coupling member;
dual function tensioning springs, seated on a movable spring seat and in association with the first and second devises to urge the locking mechanism into a locked position and to urge the universal joint into a centered position coaxial with the drive axis;
said first and second devises each having flexing clevis arms, tending to urge the universal joint into a centered position coaxial with the drive axis;
said first and second coupler axes are spaced from one another a distance less than the diameters of said pivot pins;
said universal joint supports sockets close the drive axis at rest and limits movement skewed to the drive axis to substantially 45°.

11. The locking universal joint of claim 10 further comprising:
said second clevis member has an exterior channel machined in a drive stub and an intersecting transverse slot for slidably receiving a substantially “T” shaped slide key;
said slide key “T” is formed of a vertical control bar and a transverse actuator;
said vertical control bar structure selectably bears on a locking ball arrangement for locking a tool to the drive stub;
actuator has two opposed arms which project transversely outwardly of said slot and having ends are receivable in a sleeve;
said sleeve capturing said ends.

12. The locking universal joint of claim 11 said coupling member further comprising:
first and second opposed pairs of pin receiving apertures being defined by first and second cylindrical walls and having first and second pin axes respectively being said axes are formed in said coupling member so said axes are perpendicular but longitudinally spaced from one another;
said walls being formed and arranged spacially so that if projected to extend through said member, said projected walls would intersect.

13. The locking universal joint of claim 12 said further comprising:
said first and second clevis members each having projecting clevis arms on opposite sides from one another;
said arms having cylindrical walls formed and positioned so that they are coaxial with said coupling member cylindrical walls when said universal joint is assembled;
said arm cylindrical walls and coupling member cylindrical walls are threaded so that the threads are synchronized;
said threaded cylindrical walls receiving correspondingly threaded pins;
said threaded pins, coupling member and arms coacting so that rotation of the universal joint and concomitant divergence from the longitudinal axis will tend to flex said arms.

14. The locking universal joint of claim 13 said further comprising:
a primary tensioning member fitted to urge said universal joint toward alignment along said drive axis;
a floating saddle fitted between the arms of said first clevis member;
said coupling member has tension member receiving lands formed therein;
said tension member being received by said saddle and being interposed between said saddle and said coupling member.
